(19) United States
(12) Patent Application Publication
(10) Pub. No.: US 2023/0266130 A1
(43) Pub. Date: Aug. 24, 2023

(54) System and method for providing route recommendation

(71) Applicants: Maneesh Mahlawat, Mountain View, CA (US); Kirti Mahlawat, Mountain View, CA (US); Mohit Bahadur Singh, Milpitas, CA (US); Venkatesh Nellore, Tirupati (IN)

(72) Inventors: Maneesh Mahlawat, Mountain View, CA (US); Kirti Mahlawat, Mountain View, CA (US); Mohit Bahadur Singh, Milpitas, CA (US); Venkatesh Nellore, Tirupati (IN)

(73) Assignee: Mapup Inc, SUNNYVALE, CA (US)

(21) Appl. No.: 17/678,048

(22) Filed: Feb. 23, 2022

(51) Int. Cl. G01C 21/34; G01C 21/36

(52) U.S. Cl. CPC G01C 21/3415; G01C 21/3461; G01C 21/3484; G01C 21/3492; G01C 21/3476; G01C 21/3617; G01C 21/3641

(57) ABSTRACT

A method performed by a platform for recommending route. The method includes receiving a first plurality of cost inputs, a second plurality of travel time inputs, and a third plurality of user associated inputs. Based on the received inputs, the method further includes recommending one or more routes to the user. Thereafter, the method includes receiving a selection of a route by the user, and monitoring the selection of routes over a predetermined time period. Based on the monitoring of the selection of the routes by the user, the method includes modifying the recommendations of the one or more routes for a next set of trips of the user. The modified recommendation includes recommendation to change a travel pattern of the user, which is further based on travel patterns of one or more other users.

### FIELD OF THE INVENTION

The present invention relates to a system and method for providing route recommendation, and more specifically to a system and method for providing route recommendation to a user based on user's preferences, travel time, travel cost, and other users' travel patterns.

### BACKGROUND OF THE INVENTION

Typically, when a user has to travel from a start location to a destination location, he uses the navigation system of his vehicle or his handheld electronic device for guidance on the routes. Navigation system typically receives location information of the device from a global positioning system (GPS), and provides guidance/directions to the user to travel from the start location to the destination location. The guidance/directions may be provided through audio or visual instructions. These navigation systems are quite beneficial as they save time and money for the users, as they usually recommend the “best” route in terms of time or cost savings for the users.

Conventionally, the navigation system recommends/selects a specific route based on physical road attributes, road characteristics such as speed limit and traffic lights, shortest distance, shortest time, and historical traffic information on the road network. However, such recommendation is not adaptive or customized and hence may not be desirable at all times. In other words, the conventional navigation system provides the same recommendation to multiple users who are traveling from the same start location to the same destination location, at the same time.

Thus, there is a need for a system and method to effectively provide customized route guidance to different users to improve their travel experience.

### SUMMARY OF THE INVENTION

The present invention is directed towards a platform for recommending routes to a user. The platform includes a transceiver that may be configured to receive a first plurality of cost inputs including one or more of: real time fuel cost at a plurality of fuel stations on a road network, vehicle fuel efficiency for one or more vehicles associated with the user, vehicle maintenance cost for the one or more vehicles associated with the user, insurance cost for the one or more vehicles associated with the user, driver wages, real time toll information for a plurality of tolls on the road network, travel associated cost, and real time Government tax information. The transceiver may be further configured to receive a second plurality of travel time inputs including one or more of: real time and historical traffic data on the road network, real time accident and road construction information on the road network, and real time data for events, flights and transit times. The transceiver may be further configured to receive a third plurality of user associated inputs including one or more of: habits and preferences of the user, energy preference of the user, travel budget of the user, emotional status of the user, historical travel pattern of the user, purpose of travel, and to-do list of the user. The platform further includes a processor that may be communicatively coupled to the transceiver. The processor may be configured to recommend one or more routes to the user based on the first plurality of cost inputs, the second plurality of travel time inputs, and the third plurality of user associated inputs. The transceiver may be further configured to receive a selection of a route, from one or more recommended routes, by the user. Based on the received selection of routes, the processor may be further configured to monitor the selection of routes by the user over a predetermined time period. Based on the monitoring of the selection of the routes by the user, the processor may be configured to modify the recommendation of the one or more routes for a next set of trips of the user. The processor may be further configured to provide the modified recommendation of the one or more routes to the user. The modified recommendation includes a recommendation to change a travel pattern of the user and corresponding route, based on the monitored selection of the routes by the user and travel patterns of one or more other users.

In accordance with further embodiment of the present invention, the processor may be further configured to estimate travel cost corresponding to a plurality of routes on the road network from the first plurality of cost inputs.

In accordance with further embodiment of the present invention, the processor may be further configured to estimate travel time corresponding to the plurality of routes on the road network from the second plurality of travel time inputs.

In accordance with further embodiment of the present invention, the processor may be further configured to correlate the estimation of the travel cost and the travel time, with one or more inputs from the third plurality of user associated inputs, and recommend the one or more routes from the plurality of routes based on the correlation.

In accordance with further embodiment of the present invention, the transceiver may be further configured to receive supplementary user profile information associated with the user and a plurality of other users. The supplementary user profile information includes one or more of: home location, office location, interests, income level, credit card spend information, employer information, average time spent in one or more activities, and start and destination locations for one or more trips undertaken by the user and the plurality of other users over a predefined interval of time.

In accordance with further embodiment of the present invention, the processor may be further configured to compare the supplementary user profile information of the plurality of other users and the supplementary user profile information of the user.

In accordance with further embodiment of the present invention, the processor may be further configured to calculate similarity scores of each of the plurality of other users based on the comparison, and identify the one or more other users, from the plurality of other users, having the calculated similarity scores greater than a threshold value.

In accordance with further embodiment of the present invention, the transceiver may be further configured to receive historical travel pattern information of the one or more other users. In addition, the processor may be configured to provide scores to the historical travel pattern of the one or more other users based on a predefined criteria; identify a relevant travel pattern having score greater than a predetermined threshold; and recommend the change in the travel pattern of the user based on the identification of the relevant travel pattern.

In accordance with further embodiment of the present invention, the processor may be further configured to identify a second user, from the one or more other users, based on a determination that the second user is connected to the user through a social network; and recommend the change in the travel pattern of the user based on the travel pattern of the second user.

In accordance with further embodiment of the present invention, the transceiver may be further configured to enable the user to communicate with the plurality of other users.

In accordance with further embodiment of the present invention, the transceiver may be further configured to receive information associated with a plurality of new location points of interest on the road network. In addition, the processor may be further configured to identify one or more location categories for the plurality of new location points of interest. The one or more location categories are identified from a database that includes a mapping of a plurality of locations on the road network with a plurality of location categories. The processor is further configured to determine at least one location category from the one or more location categories that are relevant to the user, based on the third plurality of user associated inputs; and recommend the change in the travel pattern of the user based on the determined at least one location category.

The present invention is further directed towards a method for recommending routes to a user. The method includes receiving a first plurality of cost inputs including one or more of: real time fuel cost at a plurality of fuel stations on a road network, vehicle fuel efficiency for one or more vehicles associated with the user, vehicle maintenance cost for the one or more vehicles associated with the user, insurance cost for the one or more vehicles associated with the user, driver wages, real time toll information for a plurality of tolls on the road network, travel associated cost, and real time Government tax information. The method further includes receiving a second plurality of travel time inputs including one or more of: real time and historical traffic data on the road network, real time accident and road construction information on the road network, and real time data for events, flights and transit times. The method further includes receiving a third plurality of user associated inputs including one or more of: habits and preferences of the user, energy preference of the user, travel budget of the user, emotional status of the user, historical travel pattern of the user, purpose of travel, and to-do list of the user. Based on the first plurality of cost inputs, the second plurality of travel time inputs, and the third plurality of user associated inputs, the method includes recommending one or more routes to the user. The method further includes receiving a selection of a route, from one or more recommended routes, by the user, and monitoring the selection of routes by the user over a predetermined time period. Based on the monitoring of the selection of the routes by the user, the method further includes modifying the recommendations of the one or more routes for a next set of trips of the user, and providing the modified recommendation of the one or more routes to the user. The modified recommendation includes a recommendation to change a travel pattern of the user and corresponding route, based on the monitored selection of the routes by the user and travel patterns of one or more other users.

In accordance with further embodiment of the present invention, the method includes estimating travel cost corresponding to a plurality of routes on the road network from the first plurality of cost inputs.

In accordance with further embodiment of the present invention, the method includes estimating travel time corresponding to the plurality of routes on the road network from the second plurality of travel time inputs.

In accordance with further embodiment of the present invention, the method includes correlating the estimation of the travel cost and time, with one or more inputs from the third plurality of user associated inputs, and recommending the one or more routes from the plurality of routes based on the correlation.

In accordance with further embodiment of the present invention, the method includes receiving supplementary user profile information associated with the user and a plurality of other users. The supplementary user profile information includes one or more of: home location, office location, interests, income level, credit card spend information, employer information, average time spent in one or more activities, and start and destination locations for one or more trips undertaken by the user and the plurality of other users over a predefined interval of time.

In accordance with further embodiment of the present invention, the method includes comparing the supplementary user profile information of the plurality of other users and the supplementary user profile information of the user.

In accordance with further embodiment of the present invention, the method includes calculating similarity scores of each of the plurality of other users based on the comparison, and identifying one or more users, from the plurality of other users, having the calculated similarity scores greater than a threshold value.

In accordance with further embodiment of the present invention, the method includes receiving historical travel patterns of the one or more other users, and providing scores to the historical travel pattern of the one or more other users based on a predefined criteria. The method includes identifying a relevant travel pattern having score greater than a predetermined threshold, and recommending the change in the travel pattern of the user based on the identification of the relevant travel pattern.

In accordance with further embodiment of the present invention, the method includes identifying a second user, from the one or more other users, based on a determination that the second user is connected to the user through a social network, and recommending the change in the travel pattern of the user based on the travel pattern of the second user.

### BRIEF DESCRIPTION OF THE DRAWINGS

FIG. 1 illustrates an environment where the present invention may be implemented, in accordance with an embodiment of the present invention.

FIG. 2 illustrates a system for recommending one or more routes to a user, in accordance with an embodiment of the present invention.

FIG. 3 illustrates examples of a plurality of inputs that are used by the system for recommending one or more routes to a user, in accordance with an embodiment of the present invention.

FIG. 4 illustrates a method for recommending one or more routes to a user, in accordance with an embodiment of the present invention.

FIG. 5 illustrates a method for recommending a change in travel pattern of a user, in accordance with an embodiment of the present invention.

### DETAILED DESCRIPTION

Hereinafter, the preferred embodiments of the present disclosure will be described in conjunction with the accompanying drawings. It should be understood that the preferred embodiments described herein are only used to illustrate and explain the present disclosure and are not intended to limit the present disclosure.

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of,” the like.

As used herein, the singular forms “a”, “an”, and “the” designate both the singular and the plural, unless expressly stated to designate the singular only.

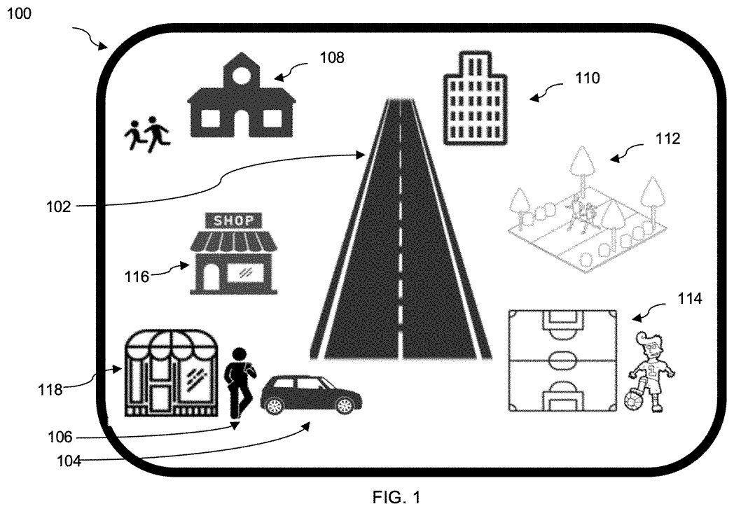

FIG. 1 illustrates an environment 100 where the present invention may be implemented, in accordance with an embodiment of the present invention. The environment 100 may correspond to a region in a metropolitan city, a state, a country, and their combinations thereof. The environment 100 may include a road network 102 on which a vehicle 104 may ply. The vehicle 104 may be, for example, large cargo vehicle, truck, car, bike, pickup truck, etc. A person ordinarily skilled in the art may appreciate that there may be a plurality of vehicles that may ply on the road network 102, without departing from the scope of the present invention.

The vehicle 104 may include a navigation/routing system (not shown in FIG. 1) which is configured to provide navigation related services to a user 106. The navigation system may be implemented by executable instructions encoded on one or more computer-readable mediums, hardware (e.g., gate level logic or one or more application specific integrated circuits (ASICs)), firmware (e.g., one or more microcontrollers with I/O capability and embedded routines for carrying out the functionality described herein), or any combination thereof. The navigation system may be built in the vehicle 104, or may be a separate computing device (such as a desktop or portable personal computer (PC), mobile telephone or portable digital assistant (PDA)) that the user 106 may use for route planning and navigation.

The user 106 may use the navigation system to receive guidance on the best route to take from a start location of his trip to the destination location. Specifically, the navigation system may be configured to receive location, velocity, direction of movement, etc. information of different vehicles (such as the vehicle 104) that are on the road network 102 from Global Positioning System (GPS), and the navigation system uses said information to provide directions to the user 106 to reach to the destination location.

In accordance with an exemplary embodiment of the present invention, the user 106 may have various activities that he has to perform during a day or throughout the week, such as dropping kids to school 108 in the morning, going to office 110 after dropping kids, going to a park 112 in the evening, taking kids to football classes 114 after the park, and going to shop 116 to buy groceries before coming back to home 118 in the evening. In addition, there may be other activities in the to-do-list of the user 106 which he has to perform.

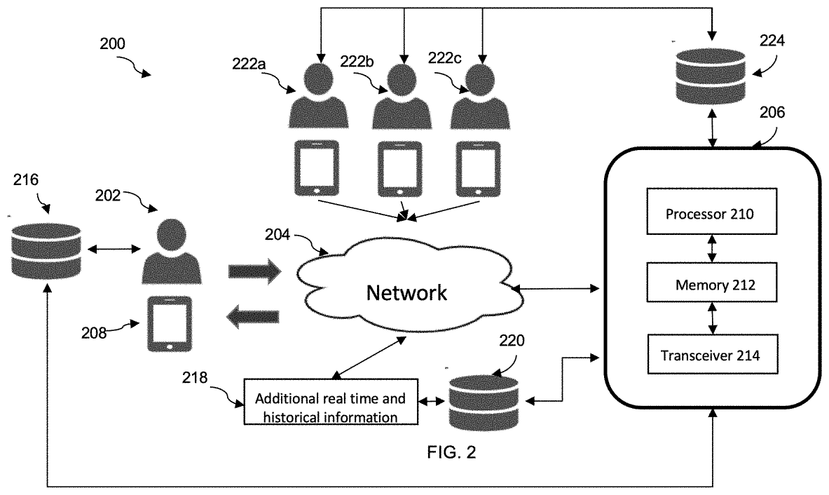

The navigation system may be configured to receive the list of activities/to-do list from the user 106, and provide recommendations of one or more routes to perform the activities based on a plurality of decision parameters. The list of activities may be received through a user device (for example, a computer, a handheld electronic device, etc.) or from a server (not shown in FIG. 1) that stores user associated inputs. The plurality of decision parameters may include, but is not limited to, user preferences, travel time, and travel cost. For instance, the navigation system may recommend the user 106 to perform grocery shopping from the shop 116 before going to the park 112 in the evening to avoid peak time traffic in that area, or to perform grocery shopping on Sunday afternoon. Thus, the navigation system may be configured to not only provide directions to the user 106 to go from a source location to a destination location, but also provide recommendation on the complete travel plan, which is personalized to the user 106. The details of the plurality of decision parameters may be understood in conjunction with FIGS. 2-5.

In accordance with further embodiments of the present invention, the navigation system may be configured to receive a selection of a route from the user 106, from the one or more recommended routes that are shown to him. The user 106 may select the route that best fits his requirements. For example, in the morning, the user 106 may select the route that saves travel time; and in the evening, he may choose the route that provides maximum cost saving. The navigation system may be configured to monitor the selection of the routes by the user 106 over a predetermined time period, to understand/learn the behavior and decision criteria of the user 106 and travel pattern of the user 106. Based on the monitoring of the selection of the routes, the navigation system may be further configured to modify the recommendations of the routes to the user 106, to further improve travel experience of the user 106. The modification includes changing of travel pattern of the user 106 to save more time and cost.

FIG. 2 illustrates a system 200 for recommending one or more routes and/or travel plan to a user 202, in accordance with an embodiment of the present invention. The system 200 may include a network 204 that may be connected to a platform or server 206 (hereinafter, platform 206 is referred to as server 206). The network 204 may be the internet, intranet, a local area network (LAN), a wide area network (WAN), wireless LAN (WLAN), wireless fidelity (Wi-Fi), and similar networks.

In accordance with an embodiment of the present invention, the user 202 may use the network 204 to connect with the server 206 to receive recommendation of one or more routes and/or travel plan. The user 202 may use a user device 208 to connect to the server 206. The user device 208 may be a communication device such as a mobile phone, a smart phone, a mobile node, a smart watch, a GPS tracking device, a personal digital assistant (PDA), a tablet computer, a laptop computer, or the like with communication capabilities.

In accordance with an embodiment of the present invention, the user 202 may access a navigation application (not shown in FIG. 2) hosted on the server 206 to receive the recommendation of the one or more routes and/or travel plan. The server 206 may be dedicated to host and run said navigation application, or may host and run a plurality of different applications. Hereinafter, for the sake of the description of the present invention, it is considered that the server 206 will perform all the operations of said navigation application.

In accordance with an embodiment of the present invention, the server 206 may include various modules such as, but not limited to, a processor 210, a memory 212, and a transceiver 214. The memory 212 may be an integrated circuit (IC) memory chip containing any form of random-access memory (RAM) or read-only memory (ROM), a floppy disk, a compact disk read-only memory (CD-ROM), a hard disk drive, a digital video disc (DVD), a flash memory card, external subscriber identity module (SIM) card or any other medium for storing non-transitory digital information.

The transceiver 214 may be configured to receive a request from the user 202 to provide recommendation of the one or more routes to the user 202. The request may be sent via the user device 208. The request may include the current location of the user device 208 (or the vehicle 104 of FIG. 1, if the user device 208 is installed in the vehicle 104, for example an in-built vehicle navigation system), and the destination location where the user 202 wants to go, as mentioned earlier. Alternatively, the user 202 may himself input the start location of his trip as part of the request that is sent to the transceiver 214, and the start location may not always be the current location of the user device 208. Furthermore, in accordance with an alternative embodiment of the present invention, the input associated with the destination location may not be required from the user 202, and the server 206 may itself “predict” the destination location, based on the historical travel pattern of the user 202. The details of such prediction are provided in the description below.

The transceiver 214 may be further configured to receive a first plurality of user associated inputs. The first plurality of user associated inputs may be received from a user information server 216 or directly from the user 202, via the network 204. In accordance with an exemplary embodiment of the present invention, the first plurality of user associated inputs may include, but is not limited to, a daily or weekly to-do list of the user 202, a historical travel pattern of the user 202, travel budget, purpose of travel, emotional status, habits and preferences, energy preference, and the like. As an example, the weekly to-do list of the user 202 may include tasks such as dropping and picking kids from the school, doing grocery shopping, going to office on weekdays, going to tennis classes on weekends, etc. The historical travel pattern may include details of the trips (such as routes, travel time, trip start locations, destination locations, etc.) made by the user 202 in the past 3 months, or 6 month, or 1 year, or even more. Travel budget may include details provided by the user 202 on the maximum amount of money that he might be willing to spend on the trips. In accordance with another embodiment of the present invention, the travel budget information may be determined by the server 206, based on the historical spend of the user 202, for example, the toll the user 202 has paid in the past, the quantity of the fuel the user 202 has purchased in the past, etc. Purpose of travel may be provided by the user 202 himself, or may be determined by the server 206 by monitoring the historical travel pattern of the user 202. For example, if the user 202 drops his kids to the school every morning at 8 AM, the server 206 may determine that the trips that the user 202 makes every morning at 8 AM are to the school (and the purpose of the trip is to drop kids to school). Emotional status may include, for example, the preference of the user 202 to take routes with scenic views at a particular time of the day or day of the week, even though the route may not be shortest one. Habits and preferences may include details such as the preference of the user 202 to stop by a fast-food shop every alternate morning on way to his office, or his preference for a particular grocery shop, etc. Another example of the user preference may be that the user 202 might prefer to take the fastest route to reach to the airport, even though the fastest route may have one or more tolls. Energy preference may include, for example, the preference of the user 202 for gas over electric for his vehicle, or vice versa. Energy preference may also include preference for a particular variant of the fuel (for example, premium or regular) that the user 202 prefers for his vehicle.

In accordance with further embodiment of the present invention, the transceiver 214 may be configured to receive additional real time and historical information 218 from another server 220, via the network 204. A person ordinary skilled in the art may appreciate that the user information server 216 can be the same as the server 220, or they may be separate servers.

In an exemplary embodiment of the present invention, the additional real time and historical information 218 may include a second plurality of travel cost inputs. For instance, the second plurality of travel cost inputs may include, but are not limited to, real time fuel cost, vehicle fuel efficiency, vehicle maintenance cost, insurance cost, driver wages, real time toll prices, and real time Government tax information. As an example, the real time fuel cost may include real time fuel costs at all the fuel stations on the road network 102. Vehicle fuel efficiency may include fuel efficiency information of all the major vehicles (including the vehicles owned by the user 202) that ply on the road network 102. For example, the server 220 may maintain a database of fuel efficiencies of all vehicles (by model type) with respect to their age. Similarly, the server 220 may also maintain a database of vehicle maintenance cost, insurance cost, etc. of all the vehicles, including the ones owned by the user 202. In addition, the server 220 may also have the latest and historical driver wages information for the drivers that ply their vehicles on the road network 102. This information is specifically stored for fleet vehicles. Real time and historical toll information may include toll prices for all the toll roads on the road network 102.

A person ordinarily skilled in the art can appreciate that the additional real time and historical information 218 may include other travel related costs as well, e.g. food or snack costs for a long trip, etc., and that may be stored in the server 220. The examples of travel cost inputs included in the additional real time and historical information 218 mentioned above should not be construed as limiting the scope of the present invention.

In accordance with further embodiment of the present invention, the additional real time and historical information 218 may include a third plurality of travel time inputs. The third plurality of travel time inputs may be received from the server 220. The third plurality of travel time inputs may include real time traffic information on the road network 102; historical traffic information on the road network 102; road data such as road condition information, and road construction information; and real time data of events, flight, transit time, accidents and the like.

In accordance with further embodiment of the present invention, the transceiver 214 may be further configured to receive information associated with a plurality of other users 222a, 222b, and 222c (collectively considered as other users 222). The transceiver 214 may be further configured to receive the information associated with the plurality of other users 222 from another server 224 or from the plurality of other users 222, via the network 204. A person ordinarily skilled in the art can appreciate that the server 224 may be the same as the servers 216 or 220, or may be a separate server. In accordance with an embodiment of the present invention, the servers 216, 220, and 224 may be a part of the server 206.

In accordance with an embodiment of the present invention, the information associated with the plurality of other users 222 may include, but is not limited to, historical travel pattern, habits and preferences, and the like (same as the information type included in the plurality of user associated inputs).

In accordance with further embodiment of the present invention, the transceiver 214 may be configured to receive supplementary user profile information associated with the user 202 and the plurality of other users 222. The supplementary user profile information includes one or more of: home location, office location, interests, income level, credit card spend information, employer information, average time spent in one or more activities, travel pattern in a group, and start and destination locations for one or more trips undertaken by the user 202 and the plurality of other users 222 over a predefined interval of time, etc.

In accordance with further embodiment of the present invention, the transceiver 214 may be configured to receive information associated with a plurality of new location points of interest from the server 220 or from the server 224. In addition to the new location points of interest, the transceiver 214 may receive a location category of the new location points of interest from the server 220 or the server 224. For example, if a new restaurant or gym is operational on the road network 102, the new location (“point of interest”) will be captured by the server 224 from internet (for example, through web-based advertisements or other online content such as local newspapers in and around the road network 102) or the information of the real time/historical trips of the plurality of other users 222 made to the new location. The server 224 may maintain a database of locations with location categories. For example, one or more other users of the plurality of other users 222 may tag the location category of the new location point of interest, and that category might be saved by the server 224. In accordance with another embodiment, the server 224 may itself tag the location category to the new location point of interest, by using Artificial Intelligence (AI) based tools run on information related to the new location point of interest, e.g. user reviews, menu or brochure, etc.

The transceiver 214 may be configured to receive the above-mentioned inputs periodically. In accordance with an exemplary embodiment of the present invention, the above-mentioned inputs may be received as and when a request from the user 202 is received for route recommendation. Alternatively, the above-mentioned inputs may be received at regular intervals of time. Also, the above-mentioned inputs may be received simultaneously or in any sequence.

As and when the above-mentioned inputs are received by the transceiver 214, they may be stored in the memory 212 of the server 206, and may be processed by the processor 210. The processor 210 may be configured to access and process the one or more inputs received by the transceiver 214.

The processor 210 may include one or more microprocessors, microcontrollers, digital signal processors (DSPs), state machines, logic circuitry, or any other device or devices that process information based on operational or programming instructions. Such operational or programming instructions may be stored in the memory 212. One of ordinary skill in the art will recognize that when the processor 210 has one or more of its functions performed by a state machine or logic circuitry, the memory 212 containing the corresponding operational instructions can be embedded within the state machine or logic circuitry.

In accordance with an embodiment of the present invention, the processor 210 may be configured to estimate the travel cost corresponding to a plurality of routes on the road network 102 from the second plurality of cost inputs. This may be done, for example, when the server 206 needs to be send one or more route recommendations to the user device 208, or when the user 202 explicitly requests for route recommendation by sending a request to the server 206 with a trip start location and a trip destination location. In addition to travel cost, the processor 210 may be further configured to estimate travel time corresponding to the plurality of routes on the road network 102 from the third plurality of travel time inputs.

In accordance with an embodiment of the present invention, the processor 210 may be further configured to correlate the first plurality of user associated inputs, the estimated travel cost, and the estimated travel time. Based on the correlation, the processor 210 may be configured to recommend one or more routes, from the plurality of routes, to the user 202 to travel from the trip start location to the destination location. The concept of correlation may be understood with the example mentioned below.

In accordance with an embodiment of the present invention, the correlation may include assigning ranking/weightage to the above-mentioned inputs at different circumstances and times. Thereafter, the processor 210 may be configured to recommend a route having highest rank corresponding to the circumstance and time. For instance, when the user 202 indicates that he is going for an important office meeting (as a “purpose of travel” in the first plurality of user associated inputs), the processor 210 may provide high weightage or rank to travel time inputs, and low weightage or rank to other inputs (e.g. related to travel cost). Based on the ranking of different inputs, the processor 210 may identify an overall rank/weight of different routes (based on the correlation). Thereafter, the processor 210 may recommend a route with highest rank. In this scenario, the processor 210 may recommend a fastest route which may be costly, as attending the office meeting takes precedence over other parameters for the user 202. In another scenario, when the user 202 is going for a leisure drive, the processor 210 may recommend a route having less traffic light and more scenic spots based on the high ranking of the first plurality of user associated inputs (and low ranking of other inputs), to provide better travel experience.

Once the recommendation is made by the processor 210, the transceiver 214 may send one or more recommended routes to the user device 208, and receive a selection of a route, from the recommended one or more routes, from the user 202. The received selection of the route may be stored in the memory 212 for further analysis. In accordance with an embodiment of the present invention, the selection of routes by the user 202 is received and stored in the memory 212 over a period of time. The processor 210 may be further configured to monitor these selection of routes by the user 202, and learn or determine the user behavior pattern and/or decision criteria of the user 202 at different times and circumstances. Also, the processor 210 may be configured to estimate value of time (VoT) of the user 202 at different circumstances and times, based on the monitoring of the selection of the routes by the user 202. Based on the determination of the user behavior pattern and the VoT of the user, the processor 210 may be further configured to modify the recommendations for next set of trips for the user 202. In other words, the processor 210 may be further configured to receive feedback from the user 202 to improve accuracy of the next set of recommendations for the user 202.

For instance, based on the monitoring of the user behavior, the processor 210 may learn that the user 202 always takes toll road while coming back from his office to home, as he needs to pick his kid from daycare. In this case, the processor 210 may provide the next set of recommendations that include the recommendation of the same toll route for the same time to the user 202 (even though this recommendation may be more expensive than the other routes available on the road network 102).

In accordance with an embodiment of the present invention, the modification of the recommendation includes recommendation of change in the travel pattern of the user 202. Specifically, based on the monitoring of the selection of the routes by the user 202, the processor 210 determines the travel pattern of the user 202. Thereafter, the processor 210 may be further configured to recommend changes to the travel pattern of the user 202, based on the second plurality of travel cost inputs, and the third plurality of travel time inputs. For instance, the processor 210 may be configured to recommend the user 202 to drop his kid 15 minutes early to school to avoid last minute school traffic rush and have a faster path to work too. Further, the recommendation may include changing a time or day for grocery shopping, or other to-do items of the user 102, to save travel time or travel cost. For example, the recommendation may be to change the time for grocery shopping from 4 PM every Sunday to 11 AM every Sunday, to avoid traffic and hence save money on fuel.

In accordance with further embodiments of the present invention, the processor 210 may be configured to recommend the change in the travel pattern of the user 202 based on the information associated with the plurality of other users 222. In accordance with an embodiment of the present invention, the processor 210 may be configured to compare supplementary user profile information of the plurality of other users 222 and the supplementary user profile information of the user 202. Based on the comparison, the processor 210 may be configured to calculate similarity score of each of the plurality of other users 222. Thereafter, the processor 210 may be further configured to identify one or more other users, from the plurality of other users 222, having similarity score greater than a predetermined threshold value. In other words, the processor 210 may be configured to identify other users who are similar to the user 202 (for example, with respect to interests, preferences, income level, staying in same area, going to the same destination locations every day/week, and the like).

Based on the identification of the one or more other users that are similar to the user 202, the processor 210 may be further configured to fetch/receive historical travel pattern of the one or more other users from the memory 212 of the server 206, received by the transceiver 214. Thereafter, the processor 210 may be configured to provide scores to the received historical travel patterns of each of the one or more other users, based on a predetermined criteria (For example time saving and cost saving). Based on the scoring, the processor 210 may be configured to select a relevant travel pattern for the user 202. In accordance with an embodiment of the present invention, the relevant travel pattern may be selected when the score of a historical travel pattern of a user is greater than a predetermined threshold.

The processor 210 may be further configured to recommend the change in the travel pattern of the user 202 based on the selection of the relevant travel pattern, to optimize the travel pattern for the user 202.

For example, the processor 210 may determine that the user 202 generally go to shop “A” for grocery shopping on weekends. Based on the historical travel pattern of the one or more other users, the processor 210 may be further configured to recommend to the user 202 to go to shop “B” (instead of shop A) to save 1 hour due to higher traffic near the shop A. In addition, the processor 210 may be configured to recommend the user 202 to go to shop B on weekdays (instead of weekends) to save more time. In this scenario, the processor 210 may be configured to select the one or more other users who stay near to the home location of the user 202, and recommend the change in the travel pattern of the user 202 based on the travel pattern of said one or more other users. In another scenario, the processor 210 may be configured to select the one or more other users who are connected to the user 202 through a social network (not shown in FIG. 2), and recommend the change in the travel pattern of the user 202 based on the travel pattern of the connected one or more other users. The social network can be a web-based social networking application, or contact list on the user device 208 of the user 202, or similar social networks. As an example, the processor 210 may identify user 202's friend Mike who goes to “XYZ” gym, which is close to the gym “ABC” where the user 202 goes. The processor 210 may recommend the user 202 to check with Mike on the feedback of “XYZ” gym. By switching to XYZ from ABC, the user 202 may save travel time and/or cost.

In accordance with another embodiment of the present invention, the relevant travel pattern that is recommended to the user 202 may be based the habits or preferences of the user 202, and user reviews of the one or more other users (and not only based on travel cost and/or time). As an example, if the user 202 frequently visits restaurant “X”, however the one or more other users rate restaurant “Y” higher than X, in this case the processor 210 may identify the route leading to restaurant Y as a relevant recommendation to the user 202.

Although in the embodiments mentioned thus far, it is described that the server 206 identifies the one or more other users 222 to provide recommendations to the user 202, however in accordance with another embodiment of the present invention, the user 202 may himself nominate one or more other users to the server 206, for whom the user 202 would prefer the server 206 to check the historical travel patterns, and accordingly recommend the changes to the travel pattern to the user 202. For example, the user 202 may nominate his tennis classmate to the server 206, and may want the server 206 to suggest travel pattern similar to the one undertaken by the user 202's classmate.

In accordance with further embodiment of the present invention, the processor 210 may be configured to fetch/receive the information associated with the plurality of new points of interest from the servers 224 or 220. Thereafter, the processor 210 may be further configured to classify the plurality of new points of interest into a plurality of categories. Alternatively, as mentioned earlier, the server 224 (or 220) may itself classify/tag the new point of interest into a location category. For instance, the plurality of new points of interest may be classified into restaurants, gyms, malls, soccer ground, and the like. Once the category of the new point of interest is tagged, the processor 210 may be further configured to determine if the category is relevant to the user 202, based on the first plurality of user associated inputs, travel pattern of the user 202 and also the location of the new point of interest. Thereafter, the processor 210 may be further configured to recommend the change in the travel pattern of the user 202 based on the new point of interest, if the tagged category is relevant to the user 202. For instance, the processor 210 may be configured to recommend to the user 202 to visit a new mall on the road network 102 on the weekend, before going out to the usual restaurant for dinner.

In accordance with an embodiment of the present invention, the transceiver 214 may be further configured to enable the user 202 to communicate with the plurality of other users 222, via the network 204.

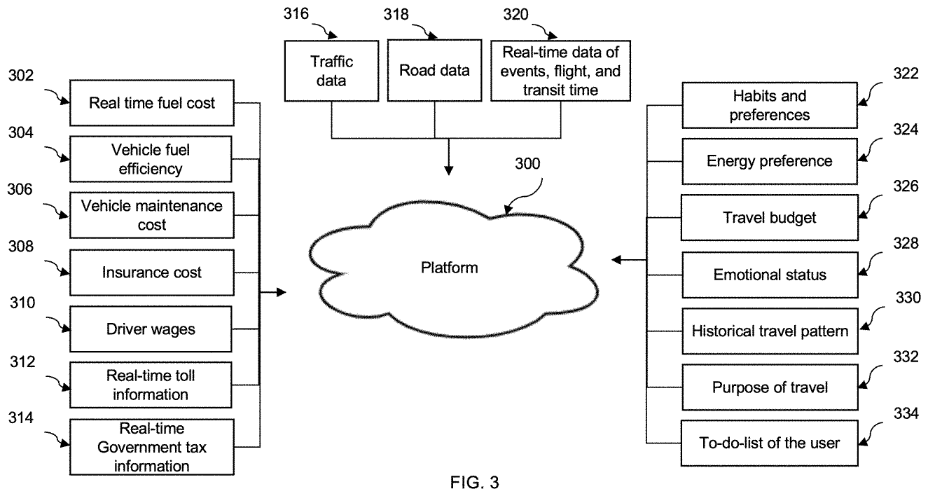

FIG. 3 illustrates examples of a plurality of inputs that are used by a platform 300 (same as the server 206) for recommending one or more routes or change of travel pattern to the user 202, in accordance with an embodiment of the present invention. The plurality of inputs may be transmitted to the platform 300 to generate recommendation of the one or more routes for the user 202.

In accordance with an embodiment of the present invention, the plurality of inputs include a first plurality of cost inputs. As mentioned in conjunction with FIG. 2, the first plurality of cost inputs may be received from the server 220. The first plurality of cost inputs may include one or more of: real time fuel cost 302, vehicle fuel efficiency 304, vehicle maintenance cost 306, insurance cost 308, driver wages 310, real-time toll information 312, real-time Government tax information 314. After receiving the first plurality of cost inputs, the platform 300 may be configured to estimate the cost of travel for the user 202. Based on the estimation, the platform 300 may be configured to recommend one or more routes to the user 202. For instance, the platform 300 may be configured to recommend a route having least tolls or a route in which a mileage of the vehicle would be high.

In accordance with further embodiment of the present invention, the plurality of inputs include a second plurality of travel time inputs. The second plurality of travel time inputs may also be received from the server 220. The second plurality of travel time inputs may include one or more of: traffic data 316, road data 318, and real-time data of events, flight, and transit time 320. The traffic data 316 may include real time congestion level on the road network 102, historical congestion level on the road network 102, real time information associated with accidents on the road network 102, and the like. The road data 318 may include road condition information and road construction information. After receiving the second plurality of travel time inputs, the platform 300 may be configured to estimate the time of travel for the user 202. Based on the estimation of the travel time, the platform 300 may be configured to recommend one or more routes to the user 202.

In accordance with further embodiment of the present invention, the plurality of inputs include a third plurality of user associated inputs. The third plurality of user associated inputs may be received from the user information server 216 or directly from the user 202 via his user device 208. In accordance with an exemplary embodiment of the present invention, the third plurality of user associated inputs may include one or more of: habits and preferences 322, energy preference 324, travel budget 326, emotional status 328, historical travel pattern 330, purpose of travel 332, to-do-list of the user 334 and other inputs such as user's decision criteria. For instance, the platform 300 may be configured to fetch the to-do list of the user 202 and recommend a route that may cover all activities mentioned in the to-do list.

After receiving the plurality of inputs as mentioned above, the platform 300 may be configured to correlate the first plurality of cost inputs, the second plurality of travel time inputs, the third plurality of user associated inputs, and other optimization inputs. The other optimization inputs may include road safety information, information associated with location of charging/refueling stations on the road network 102, etc. Based on the correlation, the platform 300 may be configured to recommend one or more routes to the user 202. For instance, the platform 300 may be configured to recommend a route providing best solar radiation based electricity generation if the user 202's preference is to use electric vehicles. Alternatively, the platform 300 may use other decision criteria to suggest the routes, for example a route based on travel time constraints of the user 202, a route through gas stations that sell some specific diesel additive that the user 202 uses in his vehicle, a safest route, and the like.

In accordance with further embodiment of the present invention, the platform 300 may be configured to fetch information associated with the plurality of other users, and determine how well each user is optimizing travel pattern based on the above-mentioned correlation. Based on the determination, the platform 300 may be configured to identify one or more users that make smart travel decisions to optimize time and/or cost (or other decision parameters, like specific interests, preferences, etc.). The one or more users may be “model” or “ideal” users that always make smart choices/decisions. Once such model users are identified, the platform 300 may be configured to recommend a change in travel pattern of the user 202 and the corresponding travel routes, based on the travel patterns of the model users. The details of providing recommendation of the routes and the change in the travel pattern of the user 202 based on the information associated with the plurality of other users are already explained above in conjunction with FIG. 2.

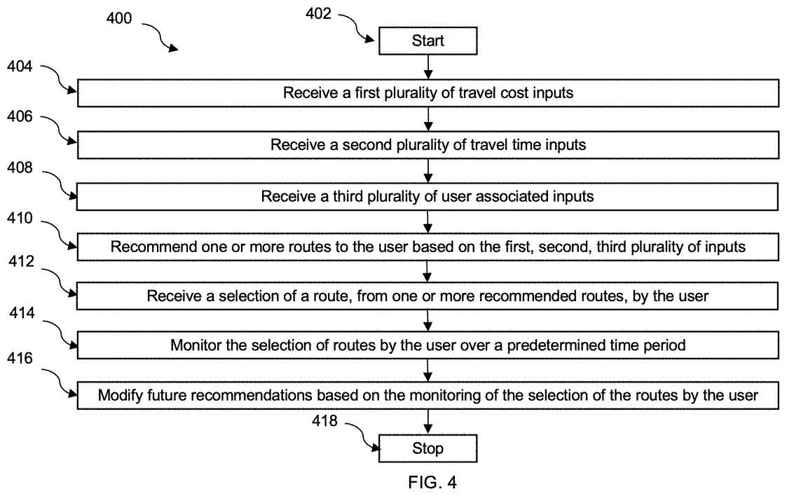

FIG. 4 illustrates a method 400 performed by the server 206 for recommending one or more routes to the user 202, in accordance with an embodiment of the present invention. The method 400 starts at 402. At step 404, the method includes receiving a first plurality of travel cost inputs. The first plurality of travel cost inputs may be received from the server 220, via the network 204. The details of the first plurality of travel cost inputs are explained above in conjunction with FIGS. 2-3. The first plurality of travel cost inputs may be received periodically, and may be stored in the server 206 as and when the first plurality of travel cost inputs are received.

The method 400 further includes receiving a second plurality of travel time inputs at step 406. The second plurality of travel time may also be received from the server 220, via the network 204. The details of the second plurality of travel time are explained above in conjunction with FIGS. 2-3. The second plurality of travel time may be received periodically, and may be stored in the server 206 as and when the second plurality of travel time inputs are received.

The method 400 further includes receiving a third plurality of user associated inputs at step 408. The third plurality of user associated inputs may be received from the user information server 216 or directly from the user 202 via the user device 208. The details of the third plurality of user associated inputs are explained above in conjunction with FIGS. 2-3. The third plurality of user associated inputs may be received periodically, and may be stored in the server 206 as and when the third plurality of user associated inputs are received.

A person ordinary skilled in the art may appreciate that the steps 404, 406, and 408 may be performed simultaneously or in any order. For instance, the third plurality of user associated inputs may be received first, and then the first plurality of travel cost inputs and the second plurality of travel time inputs may be received simultaneously.

Furthermore, the method 400 includes a step 410 for recommending one or more routes to the user 202 based on the first plurality of travel cost inputs, the second plurality of travel time inputs, the third plurality of user associated inputs, and their combination thereof. The recommendation mechanism is already explained above in conjunction with FIGS. 2-3.

Once the recommendation is provided to the user 202, the method 400 moves to step 412. At this step, the method 400 includes receiving a selection of a route, from the one or more recommended routes, by the user 202. Thereafter, the method 400 includes monitoring the selection of the routes over a predetermined time period at step 414 to understand the user behavior at different circumstances and times. Based on the monitoring of the selection by the user 202, the method moves to step 416 where the server 206 modifies the recommendation for next set of trips for the user 202. The modification may include recommendations of different routes or change in a travel pattern of the user 202, as already explained in conjunction with FIGS. 2 and 3. The method ends at step 418.

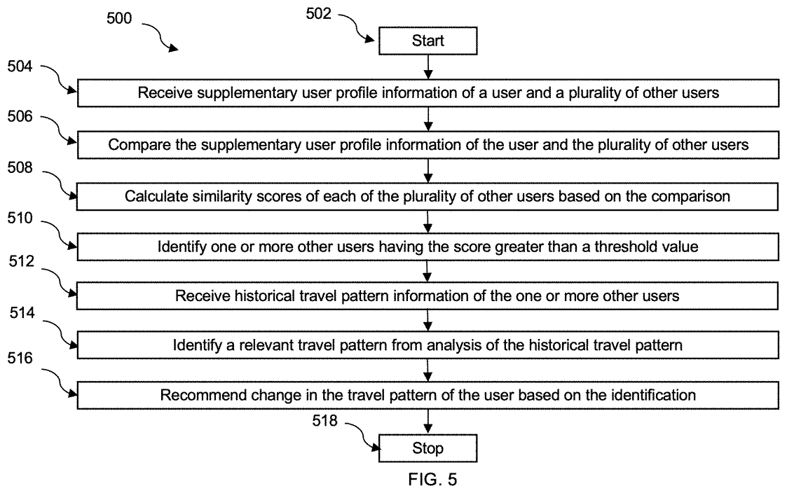

FIG. 5 illustrates a method 500 performed by the server 206 for recommending a change in the travel pattern of the user 202, in accordance with an embodiment of the present invention. The method 500 starts at step 502. At step 504, the method 500 includes receiving supplementary user profile information associated with the user 202 and the plurality of other users 222, from the server 224. The supplementary user profile information includes one or more of: home location, office location, interests, income level, credit card spend information, employer information, average time spent in one or more activities, travel pattern in a group, and start and destination locations for one or more trips undertaken by the user 202 and the plurality of other users 222 over a predefined interval of time.

Once the supplementary user profile information is received, the method 500 moves to step 506. At step 506, the method 500 includes comparing the supplementary user profile information of the user 202 with the supplementary user profile information of the plurality of other users 222. Based on the comparison, the server 206 calculates similarity scores of each of the plurality of other users 222 at step 508. Thereafter, at step 510, the method 500 includes identifying one or more other users, from the plurality of other users 222, having similarity score greater than a predetermined threshold value. Once the one or more users are identified, the method moves to step 512 in which the historical travel pattern of the one or more other users are fetched or received from the memory 212 of the server 206.

Once the historical travel pattern of the one or more other users are fetched, the method 500 moves to step 514 for identifying a relevant travel pattern for the user 202. For the identification, the server 206 may be configured to provide scores to the received historical travel patterns of each of the one or more other users, based on time saving and cost saving (or other parameters like user reviews of the places visited by the user 202 and the one or more other users, etc.). Based on the scoring, the server 206 may be configured to select a relevant travel pattern for the user 202. Thereafter, at step 516, the method 500 includes recommending a change in the travel pattern of the user 202 based on the identified or selected travel pattern. The method ends at step 518.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments that fall within the scope of the appended claims.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method described herein. Alternatively, some or all functions could be implemented by a state machine that has no stored program instructions, or in one or more application specific integrated circuits (ASICs), in which each function or some combinations of certain of the functions may be implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM, a Programmable Read Only Memory (PROM), an Erasable Programmable Read Only Memory (EPROM), an Electrically Erasable Programmable Read Only Memory (EEPROM) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. The present disclosure may be realized in hardware, or a combination of hardware and software. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

I/We claim:

1. A platform for recommending route to a user, the platform comprising:
a transceiver configured to:
receive a first plurality of cost inputs comprising one or more of: real time fuel cost at a plurality of fuel stations on a road network, vehicle fuel efficiency for one or more vehicles associated with the user, vehicle maintenance cost for the one or more vehicles associated with the user, insurance cost for the one or more vehicles associated with the user, driver wages, real time toll information for a plurality of tolls on the road network, travel associated cost, and real time Government tax information;
receive a second plurality of travel time inputs comprising one or more of: real time and historical traffic data on the road network, real time accident and road construction information on the road network, and real time data for events, flights and transit times; and
receive a third plurality of user associated inputs comprising one or more of: habits and preferences of the user, energy preference of the user, travel budget of the user, emotional status of the user, historical travel pattern of the user, purpose of travel, and to-do list of the user; and
a processor communicatively coupled to the transceiver, wherein the processor is configured to:
recommend one or more routes to the user based on the first plurality of cost inputs, the second plurality of travel time inputs, and the third plurality of user associated inputs,
wherein the transceiver is further configured to receive a selection of a route, from one or more recommended routes, by the user, and wherein the processor is further configured to:
monitor the selection of routes by the user over a predetermined time period;
modify the recommendation of the one or more routes for a next set of trips of the user, based on the monitoring of the selection of the routes by the user; and
provide the modified recommendation of the one or more routes to the user,
wherein the modified recommendation comprises a recommendation to change a travel pattern of the user and corresponding route, based on the monitored selection of the routes by the user and travel patterns of one or more other users.

2. The platform of claim 1, wherein the processor is further configured to estimate travel cost corresponding to a plurality of routes on the road network from the first plurality of cost inputs.

3. The platform of claim 2, wherein the processor is further configured to estimate travel time corresponding to the plurality of routes on the road network from the second plurality of travel time inputs.

4. The platform of claim 3, wherein the processor is further configured to:
correlate the estimation of the travel cost and the travel time, with one or more inputs from the third plurality of user associated inputs; and
recommend the one or more routes from the plurality of routes based on the correlation.

5. The platform of claim 1, wherein the transceiver is further configured to receive supplementary user profile information associated with the user and a plurality of other users, and wherein the supplementary user profile information comprises one or more of: home location, office location, interests, income level, credit card spend information, employer information, average time spent in one or more activities, and start and destination locations for one or more trips undertaken by the user and the plurality of other users over a predefined interval of time.

6. The platform of claim 5, wherein the processor is further configured to compare the supplementary user profile information of the plurality of other users and the supplementary user profile information of the user.

7. The platform of claim 6, wherein the processor is further configured to:
calculate similarity scores of each of the plurality of other users based on the comparison; and
identify the one or more other users, from the plurality of other users, having the calculated similarity scores greater than a threshold value.

8. The platform of claim 7, wherein the transceiver is further configured to receive historical travel pattern information of the one or more other users, and wherein the processor is further configured to:
provide scores to the historical travel pattern of the one or more other users based on a predefined criteria;
identify a relevant travel pattern having score greater than a predetermined threshold; and
recommend the change in the travel pattern of the user based on the identification of the relevant travel pattern.

9. The platform of claim 8, wherein the processor is further configured to:
identify a second user, from the one or more other users, based on a determination that the second user is connected to the user through a social network; and
recommend the change in the travel pattern of the user based on the travel pattern of the second user.

10. The platform of claim 5, wherein the transceiver is further configured to enable the user to communicate with the plurality of other users.

11. The platform of claim 1, wherein the transceiver is further configured to receive information associated with a plurality of new location points of interest on the road network, and wherein the processor is further configured to:
identify one or more location categories for the plurality of new location points of interest, wherein the one or more location categories are identified from a database comprising a mapping of a plurality of locations on the road network with a plurality of location categories;
determine at least one location category from the one or more location categories that are relevant to the user, based on the third plurality of user associated inputs; and
recommend the change in the travel pattern of the user based on the determined at least one location category.

12. A method for recommending route to a user, the method comprising:
receiving a first plurality of cost inputs comprising one or more of: real time fuel cost at a plurality of fuel stations on a road network, vehicle fuel efficiency for one or more vehicles associated with the user, vehicle maintenance cost for the one or more vehicles associated with the user, insurance cost for the one or more vehicles associated with the user, driver wages, real time toll information for a plurality of tolls on the road network, travel associated cost, and real time Government tax information;
receiving a second plurality of travel time inputs comprising one or more of: real time and historical traffic data on the road network, real time accident and road construction information on the road network, and real time data for events, flights and transit times;
receiving a third plurality of user associated inputs comprising one or more of: habits and preferences of the user, energy preference of the user, travel budget of the user, emotional status of the user, historical travel pattern of the user, purpose of travel, and to-do list of the user;
recommending one or more routes to the user based on the first plurality of cost inputs, the second plurality of travel time inputs, and the third plurality of user associated inputs;
receiving a selection of a route, from one or more recommended routes, by the user;
monitoring the selection of routes by the user over a predetermined time period;
modifying the recommendations of the one or more routes for a next set of trips of the user, based on the monitoring of the selection of the routes by the user; and
providing the modified recommendation of the one or more routes to the user;
wherein the modified recommendation comprises a recommendation to change a travel pattern of the user and corresponding route, based on the monitored selection of the routes by the user and travel patterns of one or more other users.

13. The method of claim 12 further comprises estimating travel cost corresponding to a plurality of routes on the road network from the first plurality of cost inputs.

14. The method of claim 13 further comprises estimating travel time corresponding to the plurality of routes on the road network from the second plurality of travel time inputs.

15. The method of claim 14 further comprises:
correlating the estimation of the travel cost and time, with one or more inputs from the third plurality of user associated inputs; and
recommending the one or more routes from the plurality of routes based on the correlation.

16. The method of claim 12 further comprises receiving supplementary user profile information associated with the user and a plurality of other users, and wherein the supplementary user profile information comprises one or more of: home location, office location, interests, income level, credit card spend information, employer information, average time spent in one or more activities, and start and destination locations for one or more trips undertaken by the user and the plurality of other users over a predefined interval of time.

17. The method of claim 16 further comprises comparing the supplementary user profile information of the plurality of other users and the supplementary user profile information of the user.

18. The method of claim 17 further comprises:
calculating similarity scores of each of the plurality of other users based on the comparison; and
identifying one or more users, from the plurality of other users, having the calculated similarity scores greater than a threshold value.

19. The method of claim 18 further comprises:
receiving historical travel pattern of the one or more other users;
providing scores to the historical travel pattern of the one or more other users based on a predefined criteria;
identifying a relevant travel pattern having score greater than a predetermined threshold; and
recommending the change in the travel pattern of the user based on the identification of the relevant travel pattern.

20. The method of claim 19 further comprises:
identifying a second user, from the one or more other users, based on a determination that the second user is connected to the user through a social network; and
recommending the change in the travel pattern of the user based on the travel pattern of the second user.
